(19) United States
(12) Patent Application Publication
(10) Pub. No.: US 2022/0355869 A1
(43) Pub. Date: Nov. 10, 2022

(54) SYSTEM AND METHOD FOR MANUFACTURING AN ENGINE BAY PROTECTOR

(71) Applicant: Walter BURHANS, Santa Clara, CA (US)

(72) Inventor: Walter BURHANS, Santa Clara, CA (US)

(21) Appl. No.: 17/736,974

(22) Filed: May 4, 2022

Related U.S. Application Data
(60) Provisional application No. 63/184,546, filed on May 5, 2021.

(51) Int. Cl. B62D 25/08; B62D 25/24

(52) U.S. Cl. CPC B62D 25/082; B62D 25/24

(57) ABSTRACT

An engine bay protector to protect the vehicle engine from intrusion of liquid through an engine ventilation opening. The engine bay protector is formed with any waterproof material, including silicone. The engine bay protector has a width, length, and thickness that corresponds with the dimensions of the engine ventilation opening that is to be covered. The engine bay protector has sufficient weight to resist movement during rain and car wash and will remain on the engine ventilation opening after placing over the engine ventilation opening during the rain and car wash.

### CROSS REFERENCE TO RELATED APPLICATIONS

The application claims the benefit of U.S. Provisional Application Ser. No. 63/184,546 filed on May 5, 2021 and titled SILICONE-BASED ENGINE BAY PROTECTOR by Walter BURHANS, the entire disclosure of which is incorporated herein by reference.

### FIELD OF THE INVENTION

The present technology is in the field of vehicle covers, and more precisely, covers for the engine bay.

### BACKGROUND

Vehicles are the second most valuable and expensive asset for most people besides their homes. Vehicles are protected by a thin layer of paint that are being constantly subjected to environmental hazards that damage the paint and which will not only affect the aesthetic of the vehicle but also diminish its value.

Various types of covers have been used to cover and protect vehicles from environmental hazards and to preserve vehicles' value and aesthetics. Covers may be made of cotton or various artificial fibers such as polyester to shield the vehicle from environmental hazards such as rain and air pollutions. Covers are available to cover the entire vehicle or certain parts of the vehicle, such as the front bumper, the windshield, or wheels and tires.

Many vehicle owners not only take pride in keeping the exterior of their vehicle clean and shiny, they also detail their vehicle, including its tires and its engine to keep the entire vehicle immaculate. Detailing an engine is a tedious, time consuming, and dirty task. There are many electronic components and hard or impossible to reach areas in the engine bay. Care must be taken in washing and cleaning the engine and the engine bay. The engine is not usually cleaned every time along with the exterior of the vehicle.

Most modern vehicles have their engine located at the front of the vehicle under the hood. However, many sports vehicles such as the late model Chevrolet Corvette, Ferraris, Porsches, etc. have their engine located behind the passenger compartment, i.e. mid-engine. An engine produces a large amount of heat and requires a constant flow of cool air to remove the heat that is generated. Therefore, there are ventilation openings in the cover on top of the engine bay to allow the heat generated by the engine to escape.

However, the engine ventilation openings must necessarily be kept open and expose the engine to the environment, including rain. This also means that every time the vehicle is washed, the engine will have water splashed onto it through the ventilation openings. The water, if not cleaned and wiped off before they are air-dried, will leave water spots on the engine, which will mar the clean, detailed engine. Since the engine is usually not washed or detailed every time the car is washed, this will leave a build-up of water spots and the moisture that is leaked through the ventilation openings will also promote corrosion of the engine and the surrounding electrical components and their contacts that are present in abundance in a modern engine.

Presently, there is no solution to prevent the intrusion of liquid through the ventilation openings so that the liquid will not reach the engine and the surrounding electrical components and their contacts.

### SUMMARY

In accordance with various embodiments and aspects of the invention, the disclosed engine bay protector will obstruct the intrusion of liquid through the engine ventilation opening.

As can be seen in FIG. 1-2, the engine bay protector may be formed with silicone and has a width, length, and thickness that corresponds with the dimensions of the engine ventilation opening that is to be covered. The engine bay protector has sufficient weight to resist movement during rain and car wash and will remain on the engine ventilation opening after placing over the engine ventilation opening during the rain and car wash.

### BRIEF DESCRIPTION OF THE DRAWINGS

In order to understand the invention more fully, a reference is made to the accompanying drawings. The invention is described in accordance with the aspects and embodiments in the following description with reference to the drawings or figures (FIG.), in which like numbers represent the same or similar elements. Understanding that these drawings are not to be considered limitations in the scope of the invention, the presently described aspects and embodiments and the presently understood best mode of the invention are described with additional detail through the use of the accompanying drawings.

FIG. 1 shows a top view of engine bay protectors in accordance with the various embodiments of the invention.

FIG. 2 shows a side view of one part of the engine bay protectors of FIG. 1 in accordance with the various embodiments of the invention.

FIG. 3 shows a side view of one part of the engine bay protectors of FIG. 1 in accordance with the various embodiments of the invention.

FIG. 4 shows a side view of one portion of the engine bay protectors of FIG. 1 in accordance with the various embodiments of the invention.

FIG. 5 shows a perspective view of a back portion of a vehicle with engine cover having vents therein.

FIG. 6 shows the engine bay protectors of FIG. 1 in accordance with the various embodiments of the invention, positioned in vents of the engine cover of FIG. 5.

FIG. 7 shows a rear view of the vehicle with the engine bay protectors in place as shown in FIG. 6, in accordance with the various embodiments of the invention.

FIG. 8A shows a top view of a portion of a mold for creating one part of the engine bay protectors in accordance with the various embodiments of the invention.

FIG. 8B shows a bottom view of the mold of FIG. 8A in accordance with the various embodiments of the invention.

FIG. 9 shows a portion of the mold of FIG. 8A with cavities for receiving shapes, letters, or numbers in accordance with the various embodiments of the invention.

### DETAILED DESCRIPTION

The following describes various aspects and embodiments of the invention. Generally, examples can use the described aspects in any combination. All statements herein reciting principles, aspects, and embodiments, as well as specific examples thereof, are intended to encompass both structural and functional equivalents thereof. The examples provided are intended as non-limiting examples. Additionally, it is intended that such equivalents include both currently known equivalents and equivalents developed in the future, i.e., any elements developed that perform the same function, regardless of structure.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

It is noted that, as used herein, the singular forms “a,” “an” and “the” include plural referents unless the context clearly dictates otherwise. Reference throughout this specification to “one aspect,” “an aspect,” “certain aspects,” “various aspects,” or similar language means that a particular aspect, feature, structure, or characteristic described in connection with any embodiment is included in at least one embodiment of the invention.

Appearances of the phrases “in one embodiment,” “in at least one embodiment,” “in an embodiment,” “in certain embodiments,” and similar language throughout this specification may, but do not necessarily, all refer to the same embodiment or similar embodiments. Furthermore, aspects and embodiments of the invention described herein are merely exemplary, and should not be construed as limiting of the scope or spirit of the invention as appreciated by those of ordinary skill in the art. The disclosed invention is effectively made or used in any embodiment that includes any novel aspect described herein. All statements herein reciting aspects and embodiments of the invention are intended to encompass both structural and functional equivalents thereof. It is intended that such equivalents include both currently known equivalents and equivalents developed in the future.

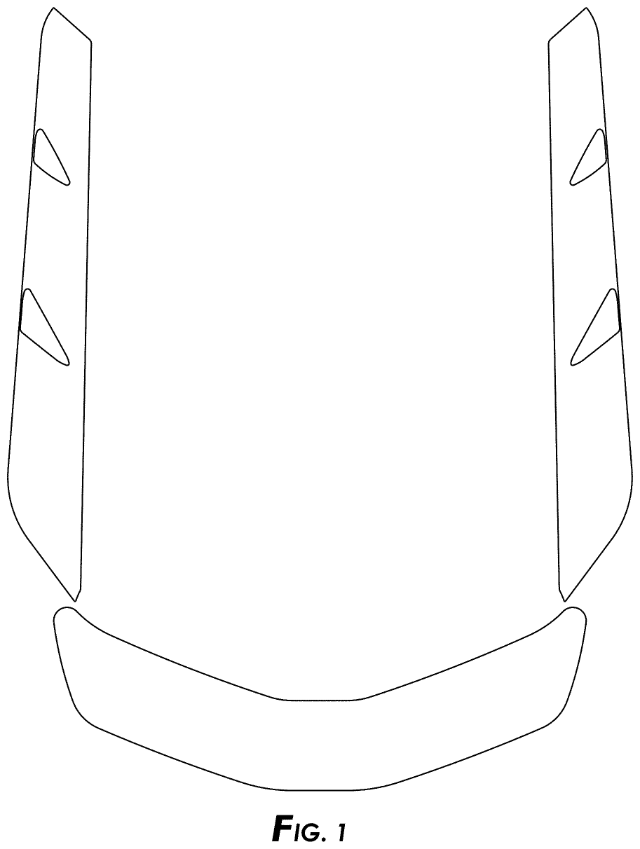

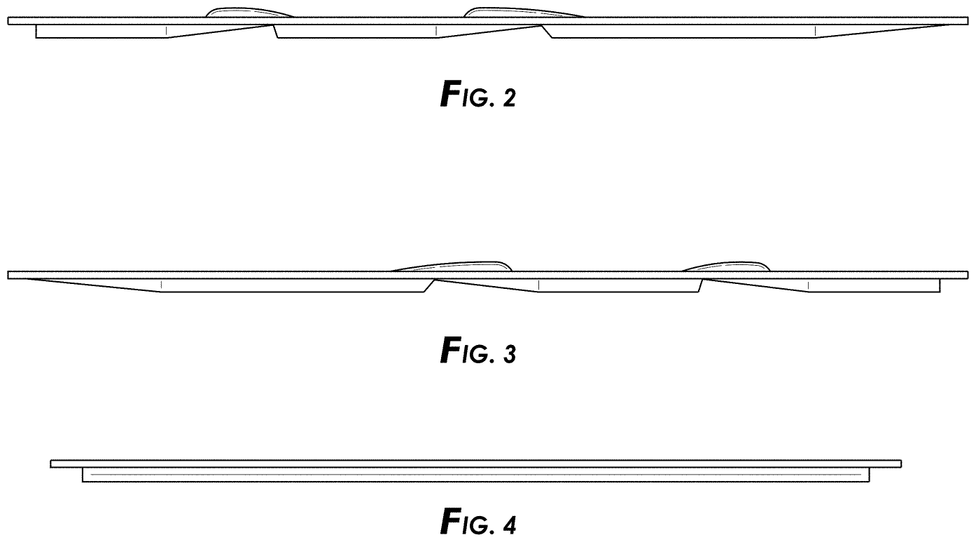

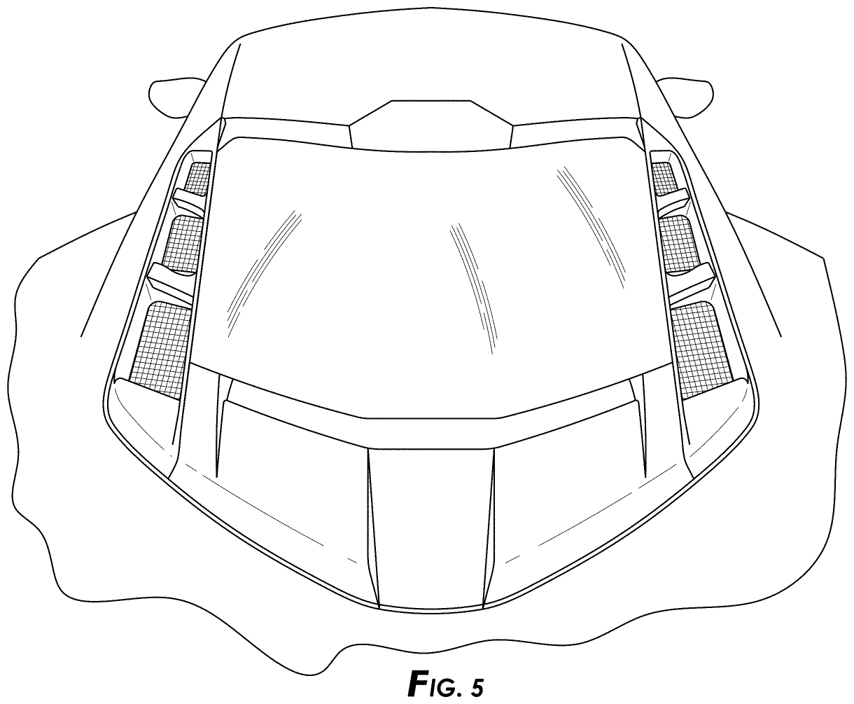

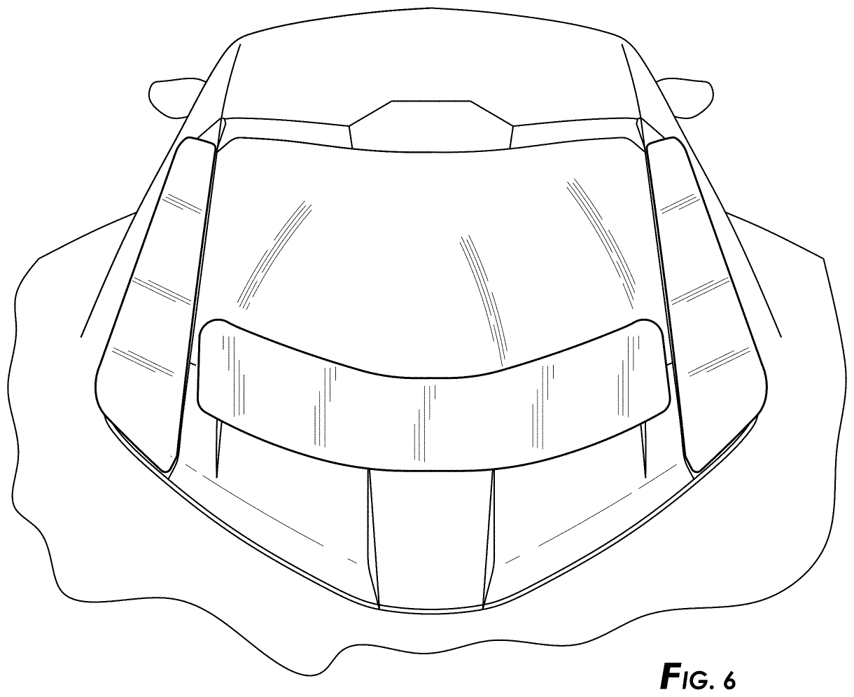

Referring to FIG. 1-4, engine bay protectors (or covers) are shown, according to the various embodiments of the invention, that are placed over (and inserted into place within the depth of) engine ventilation openings to obstruct (and prevent or significantly reduce) the intrusion of liquid through the engine ventilation opening into the engine compartment and onto the engine. In accordance with some embodiments, the engine bay protectors may be made of silicone and have a width, length, and thickness that corresponds with the dimensions of the engine ventilation opening of an engine bay hood/cover for a vehicle, shown in FIG. 5. Silicone is a preferred material, selected from many different possible materials, due to its properties with respect to resistance to sun damage, burn resistant, shrink resistant, and does not decompose or rot when exposed to environmental conditions over the life of the product. The engine ventilation opening is to be covered during cleaning of the car to avoid entry of water. In this example, the vehicle shown is a late model Chevrolet Corvette. The scope of the invention is not limited by the type of vehicle, as any vehicle with engine ventilation openings can benefit from the disclosure and embodiments of the invention.

The engine bay protectors may be made of any suitable material that has sufficient flexibility and weight to form the engine bay protectors. The engine bay protectors have sufficient flexibility to form a seal, around its circumference, when in contact with the vehicle to seal the engine ventilation opening.

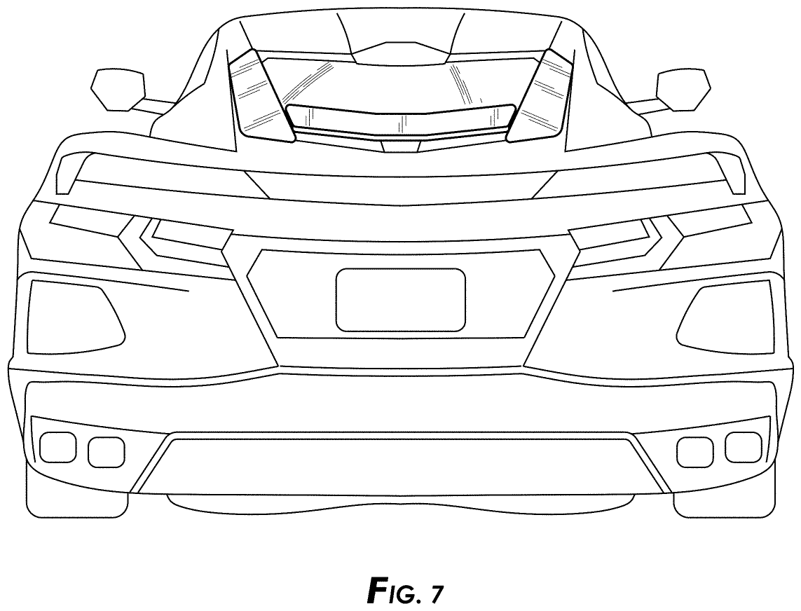

Referring again to FIG. 5 and now to FIG. 6 and FIG. 7, the engine ventilation openings are shown for on a late model Chevrolet Corvette. In accordance with some embodiments, the engine bay protectors have sufficient weight to resist movement during rain and/or a car wash and will remain on the engine ventilation opening after being placed over the engine ventilation opening as shown in FIG. 6. In accordance with some embodiments of the invention, the engine bay protectors include mechanical clips to assist in resistance to movement during rain and/or a car wash. In accordance with some embodiments of the invention, the various portions of the engine bay protectors may be connected/combined into one piece (using an appropriate shaped mold) to result in greater weight that helps keep the engine bay protections in place and avoid movement after being placed over the engine ventilation opening. Engine ventilation openings of other vehicles, such as Ferraris and Porsches, may be similarly covered with correspondingly dimensioned engine bay protectors. As noted, the scope of the invention is not limited by the type of vehicle or the shape and size of the engine ventilation openings.

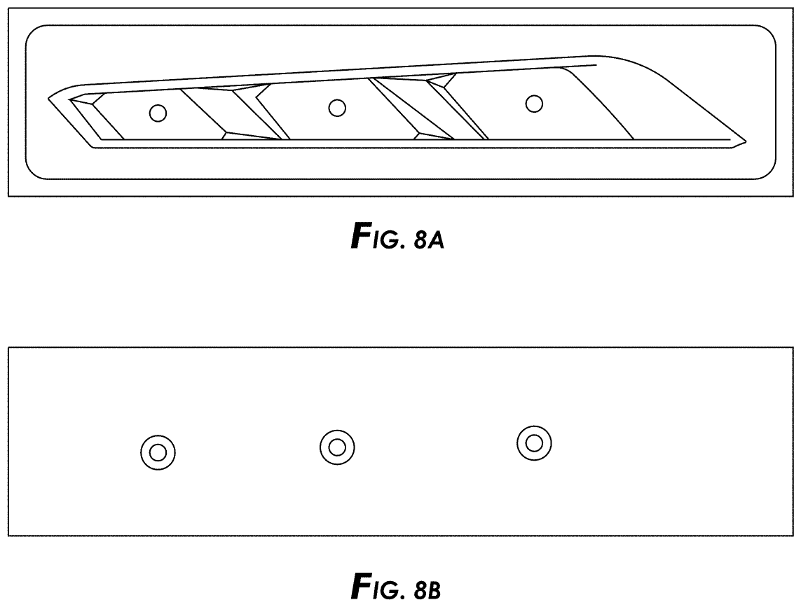

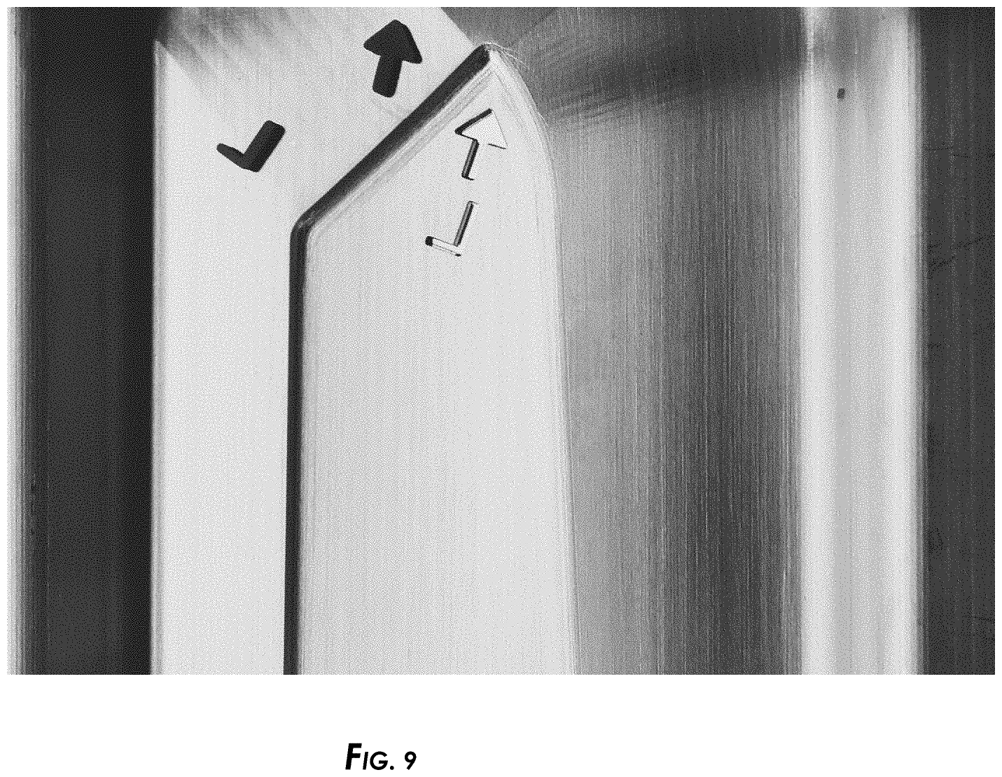

Referring now to FIG. 8A and FIG. 8B, a mold is shown in accordance with some embodiments of the invention and as an example of one portion of the engine bay protector of FIG. 1. Molds are also produced, using a similar process, for the other portions of the engine bay protectors. The engine bay protectors are formed by first determining the dimensions of the engine ventilation opening. In accordance with one aspect of the invention, the dimensions are determined with 3-D scanning technology. In accordance with one aspect of the invention, the dimensions are determined using manual measurements. In accordance with one aspect of the invention, the dimensions are determined using any known or later developed 3-D image generation technology. Once the dimensions of the engine ventilation opening are determined, a mold is created based on the dimensions. The mold has a shape that defines a cavity, which cavity matches the engine ventilation opening's shape, depth, and width. Then the material, which is used to form the engine bay protectors, is prepared. The engine bay protector is then formed by placing, injection, or pouring the material into the mold. After the engine bay protector is formed and hardened, it is then removed from mold.

Referring now to FIG. 9, a portion of the mold of FIG. 8A is shown. In accordance with one aspect and embodiment of the invention, the mold includes defined cavities for receiving preformed shapes, alpha-numeric letters, which can spell specific words or a single letter, and/or numbers. The letters/numbers are placed into the cavities in the mold before the material is introduced to the mold. In this non-limiting example, the letter “L” and the shape of an arrow are shown with corresponding cavities for receiving the letter “L” and the arrow. The letter and shape are used as a guide (or directional instruction) for placement of the engine bay protector (cover) by the user Once the material is introduced into the mold, it hardens and holds the letters in place. The words are then a permanent part of the engine bay protectors and can act as instructions or warnings to the user.

In accordance with one embodiment of the invention, the engine bay protectors are formed in a mold, preferably an injection molding process, and the material used is made of silicone that is injected into the mold and cures over time. Injection molding is a manufacturing process that produces parts by injecting molten or viscous material, such as silicone, into the mold. In accordance with one embodiment, the material is in pellet form and is fed into a heated barrel and mixed using a helical screw into a molten form, which lowers its viscosity, and then forced into the mold. In accordance with one embodiment, the material is made of two or more chemicals that are mixed to form a viscous material and can be injected into a mold under pressure. The scope of the invention is not limited by the type of material used.

The material is injected into a mold. In other example embodiments the material is poured into the mold. The mold is held together by a clamp, which can be removed to separate the parts of the mold (open the mold) after the material is cured in order to release it from the mold. The mold may contain liquid cooling channels to speed up the curing process. After the material is cured and solidified, it takes the form of the mold cavity and may then be removed from the mold for use. The mold is usually made from metal such as steel or aluminum and precision machined to form the cavity for the part.

The benefit of this invention is that it will obstruct and prevent/significantly reduce the intrusion of liquid, such as water, through the engine ventilation openings, thereby, protecting the engine and the surrounding electrical components and the liquid sensitive electrical contacts.

To the extent that the terms “including,” “includes,” “having,” “has,” “with,” or variants thereof are used in either the detailed description and the claims, such terms are intended to be inclusive in a similar manner to the term “comprising.”

It will be appreciated by those skilled in the art that other various modifications could be made without parting from the spirit and scope of this disclosure. All such modifications and changes fall within the scope of the claims and are intended to be covered thereby. The scope of the invention, therefore, is not intended to be limited to the exemplary embodiments and aspects that are shown and described herein. Rather, the scope and spirit of the invention is embodied by the appended claims.

What is claimed is:

1. An engine bay protector comprising:
a cover with a width, a length, and a thickness that correspond with a width, a length, and a depth of an engine ventilation opening,
wherein the cover is capable of being placed over the engine ventilation opening to obstruct the intrusion of liquid through the engine ventilation opening.

2. An engine bay protector as in claim 1, wherein the cover is made from silicone.

3. An engine bay protector as in claim 1, wherein the cover has sufficient weight to resist movement from the engine ventilation opening during rain and car washing.

4. A method for manufacturing engine bay protection covers, the method comprising:
determining dimensions of an engine ventilation opening;
creating a mold, using the dimensions, for a cover that fits the engine ventilation opening; and
forming the cover for the engine ventilation opening using the mold,
wherein the cover obstructs the intrusion of liquid through the engine ventilation opening.

5. A method as in claim 4 further comprising the step of determining, the dimensions of the engine ventilation opening, using 3-D scanning.

6. A method as in claim 4, wherein the cover is formed by injection molding.

7. A method as in claim 4, wherein the cover is formed using silicone that is injected into the mold.

8. A system for producing an engine bay protector, the system comprising:
a mold defining a shape that corresponds to a width, a length, and a depth of an engine ventilation opening; and
a material for injection into the mold, which when hardened forms the engine bay protector,
wherein the engine bay protector is capable of being placed over the engine ventilation opening to obstruct the intrusion of liquid through the engine ventilation opening.

9. The system of claim 8, wherein the mold defines a cavity for receiving at least one of a shape, a letter, or a number.
